(19) United States
(12) Patent Application Publication
(10) Pub. No.: US 2026/0326048 A1
(43) Pub. Date: Oct. 22, 2026

(54) METHOD AND ARRANGEMENT FOR OPERATING A CONTINUOUS DOWNSTREAM PROCESS

(71) Applicant: Sartorius Stedim Biotech GmbH, Goettingen (DE)

(72) Inventors: Bernhard Diel, Dransfeld (DE); Michael Rodenberg, Einbeck (DE)

(21) Appl. No.: 19/122,122

(22) PCT Filed: Sep. 12, 2023
(86) PCT No.: PCT/EP2023/074974

§ 371 Date: Apr. 17, 2025

(30) Foreign Application Priority Data
Oct. 17, 2022 (EP) 22 201 978.8

(51) Int. Cl. B01F 23/40; B01F 35/21; B01F 35/22; B01F 35/221; B01F 35/83; B01F 101/23

(52) U.S. Cl. CPC B01F 23/483; B01F 23/49; B01F 35/2112; B01F 35/2132; B01F 35/2133; B01F 35/2202; B01F 35/2211; B01F 35/831; B01F 35/833; B01F 2101/23

(57) ABSTRACT

Method for operating a continuous downstream process, in particular a continuous virus inactivation or inline dilution process, using a bioprocess arrangement, wherein the bioprocess arrangement has an expansion tank with a first fluid inlet, set up for introducing a concentrate flow, in particular a product or buffer concentrate flow, into the tank, with at least one second fluid inlet, set up for introducing a diluent flow, in particular a product or buffer diluent flow, into the tank, with a fluid outlet, set up for discharging a liquid flow from the tank, the bioprocess arrangement having a delivery arrangement for conveying fluid, which is associated with the first fluid inlet and the second fluid inlet for conveying in each case at least one liquid flow into the tank, and with the fluid outlet for conveying a liquid flow out of the tank, and the bioprocess arrangement having an electronic process control.

### CROSS-REFERENCE TO RELATED APPLICATIONS

This application is a national stage application under 35 U.S.C. 371 of International Patent Application Serial No. PCT/EP2023/074974, entitled “Method and Arrangement for Operating a Continuous Downstream Process,” filed Sep. 12, 2023, which claims priority from European Patent Application No. 22 201 978.8, filed Oct. 17, 2022, the disclosure of which is incorporated herein by reference.

### FIELD OF THE TECHNOLOGY

Various embodiments relate to a method for operating a continuous downstream method, a bioprocess arrangement for operating a continuous downstream method, an electronic process control of the proposed bioprocess arrangement, the use of an electronic process control for implementing a proposed method, a computer program for the proposed electronic process control, and a computer-readable storage medium for storing the computer program.

### SUMMARY

The method in question for operating a continuous downstream process, in particular a continuous virus inactivation or inline dilution process, is used in the context of a bioprocess for the production and/or quality control of biopharmaceutical bioproducts, in particular proteins, vectors, cells and the like, whereby a continuous flow from an upstream unit, in particular an upstream chromatography unit, can be provided for a downstream unit, in particular a downstream chromatography or filtration unit.

In process engineering, “downstream process” refers to all methods used to separate and purify fermentation products from a fermentation broth in a biotechnological process. This term includes mechanical, thermal, electrical and physico-chemical processes.

The term “bioprocess” here means biotechnological and biopharmaceutical processes involved in the production of therapeutic bioproducts, such as vaccines, biologics, components for cell or gene therapy, or non-therapeutic bioproducts such as pigments, biofuels or nutrients. Such bioproducts can either be produced by living cells or the cell itself can be the bioproduct or the bioproduct can be the result of a cell-free production based on cell components that are either of natural or non-natural origin.

In the biopharmaceutical industry, the trend is towards intensifying processes, which means that continuous process steps are being implemented more and more frequently. In batch production, as it is routinely carried out in a standardized form, the product passes through one process step after another in batches and is collected in storage containers after each of these steps. This approach can limit both the utilization of the bioprocess set-up and the productivity of the process. Continuous process control, on the other hand, means that the product passes through several production steps without interruption. Continuous processes therefore make it possible to carry out the individual steps on a much smaller scale, so that consumables such as buffers, solvents and the like can be saved and even larger processes can be carried out in single-use format. The smaller number and size of storage containers also leads to a shorter retention time of the product in the bioprocess.

The advantages of continuous production lie in particular in the previously unattainable control of product quality and better agility and flexibility in dealing with product requirements. Another advantage is the significantly reduced scale-up risk due to the smaller plant design. Continuous production therefore offers great potential for increasing the economic efficiency of bioprocesses.

As part of process intensification, new methods such as single-use centrifugation, tangential flow filtration (TFF) or rapid cycling chromatography (RCC) are increasingly being developed, all of which are aimed at achieving a continuous product flow and thus making the process steps used in the downstream process as space-and cost-saving as possible.

A first chromatography step, in particular a protein A affinity chromatography step, is regularly followed by a first virus inactivation step. The implementation of a continuous virus inactivation step represents a challenge for process development in the context of process intensification A method for operating a continuous downstream process is provided in EP 2 867 359B1 , on which some embodiments are based, is used for the semi-continuous inactivation of viruses during a protein production process, eliminating the need to use large storage tanks for virus inactivation. This is due to the fact that smaller, agitated mixing tanks are used for virus inactivation, which creates better conditions for the product and saves installation space. Furthermore, the incubation time for complete virus inactivation can be reduced from at least one hour to a maximum of one hour.

However, this is therefore also not a continuous process, as a protein A eluate is incubated with a virus-inactivating agent using a mixing tank, wherein complete virus inactivation can still take up to one hour. During this time, the protein A eluate containing the target protein must be incubated and stirred with a virus-inactivating agent for an extended period of time, similar to conventional batch processes, before proceeding to the next process step. This can be problematic, as bioproducts from bioprocesses that are fundamentally sensitive, such as an antibody, can be destroyed if the storage or process time is too long. The longer the period of agitated incubation of the bioproduct, in particular the target protein, with virus-inactivating agents, the greater the probability of destruction of the bioproduct due to the mechanical forces of the agitator and the decomposing effect of virus-inactivating agents.

Similar challenges arise when implementing a continuous inline dilution process in which two or more liquids are mixed together. Currently, the mixing of buffers or media, for example, is often practiced in sets, especially for downstream processes. A container is filled with the base liquid to be mixed and then ingredients to be mixed in are added and mixed with a mixer until the desired degree of mixing or dissolution is achieved, after which the finished solution is processed further.

Similarly to the problem of virus inactivation described above, the use of such intermediate containers also has the decisive disadvantage that process sequences are interrupted by a mixing process using a mixing tank, in which the mixing takes place in batches. This requires more time, space and equipment, which in turn results in higher costs and reduces the economic efficiency of bioprocesses.

For this reason, mixing processes should not, in some cases, be realized in intermediate containers, but “inline”, i.e., within a line of the line arrangement, so that static mixing elements are currently preferred for inline mixing. A method for operating a continuous downstream process, in particular a continuous inline dilution process (WO 2015 117 884 A1), comprises a first and at least one second chromatography column, several buffer vessels and an additional inline dilution system comprising an inlet and a bioprocess outlet. However, the additional inline dilution system requires additional manufacturing space and leads to increased material costs, higher structural complexity and higher maintenance costs.

As a result, the methods provide only limited efficiency in terms of the long process times that endanger the bioproduct on the one hand and in terms of manufacturing costs and production space utilization on the other. In general, the implementation of the known method for operating a continuous downstream process, in particular a continuous virus inactivation or inline dilution process, is relatively complex.

Various embodiments are based on the problem of designing and developing the known method for operating a continuous downstream process in such a way that its implementation is simplified.

The above problem is solved in a method for operating a continuous downstream method as described herein.

A consideration is that the electronic process control adjusts a fill level in the expansion tank by open-loop and/or closed-loop control of the delivery arrangement to prevent the fill level from falling below a minimum fill level, thereby ensuring a continuous liquid flow from the bioprocess arrangement.

The term “expansion tank” is to be understood broadly here and means any vessel or container that is designed to hold liquids. This can be made of flexible or rigid materials, in particular metal, glass, plastic or the like. Additionally or alternatively, the expansion tank can be designed for multiple use or as a single-use container.

The particular structure of the method according to the proposal for operating a continuous downstream process has the advantage of converting a liquid flow, in particular a discontinuous liquid flow, from an upstream process step, in particular an upstream protein A chromatography step, which can fluctuate in terms of volume and product concentration, in which, for example, no liquid flow flows at times and in which the product concentration can usually fluctuate during the chromatography phases, into a continuous liquid flow and of continuously discharging this liquid flow into a downstream process step following a proposed continuous downstream process, in particular a continuous virus inactivation or inline dilution process.

The term “continuous liquid flow” here means a liquid flow that is not interrupted, for example by incubation in a container or the like, but which can vary in terms of flow rate.

Specifically, it is proposed that the electronic process control adjusts a fill level in the expansion tank by open-loop and/or closed-loop control of the delivery arrangement in such a way that the fill level in the expansion tank does not fall below a predefined minimum fill level.

According to various embodiments, the electronic process control adjusts a fill level in the expansion tank in such a way that a predefined target fill level is reached or the fill level is maintained in a target fill level range. This enables the user not only to prevent the expansion tank from running empty, but also to set a predefined target fill level. This can be above the minimum fill level and is set again in particular after the fill level has fallen below or exceeded the target fill level.

Various embodiments concern details of the at least one delivery device associated with the delivery arrangement and enable flexible fluid controllability in a simple manner.

The term “delivery arrangement” is to be understood broadly in the present case and means here any type of arrangement which is set up to deliver and/or adapt, in particular interrupt, the delivery of liquids, in particular pump arrangements with at least one pump and/or valve arrangements with at least one valve. Such a pump and such a valve then each form a “delivery device” of the delivery arrangement. In various embodiments, such delivery devices are meant which are designed as metering pumps, in particular as peristaltic pumps, rotary piston pumps or diaphragm pumps. In particular, such valves are meant which are designed to establish a selective and quantitative fluidic connection, such as a continuous valve, control valve or the like.

According to various embodiments, the electronic process control derives an actual value for a fill level parameter in the expansion tank from the process data in a monitoring routine. Depending on a deviation between the derived actual value for the fill level parameter and a predefined minimum fill level in the expansion tank corresponding to a predefined minimum value for the fill level parameter, the electronic process control adjusts the delivery rate of the first, second and/or third delivery device to prevent the fill level from falling below the minimum fill level. This configuration enables the electronic process control to react to any deviation from the minimum fill level and prevent it from falling below by adjusting the corresponding pumps. Alternatively, the adjustment is made depending on a deviation between the derived actual value for the fill level parameter and a predefined target value for the fill level parameter corresponding to the predefined target fill level in the expansion tank, the delivery rate of the first, second and/or third delivery device to reach the target fill level or depending on a deviation between the derived actual value for the fill level parameter and a predefined limit value of the predefined target fill level range in the expansion tank, the delivery rate of the first, second and/or third delivery device to maintain the fill level in the target fill level range.

According to various embodiments, the electronic process control generates a first model from the process data. The degree of adjustment of the delivery rate is derived from this first model. This embodiment offers the advantage that the process is not only controllable by adjusting the delivery rate of the first, second and/or third delivery device, but that this control can be carried out automatically by the underlying first model.

Based on the process data it contains, the first model represents the dependency between the fill level parameter in the expansion tank on the one hand and the delivery rate of the first, second and/or third delivery device on the other.

According to various embodiments, the bioprocess arrangement has a first bioprocess inlet and a fourth delivery device associated therewith, which is set up for the metered delivery of a liquid flow into the line arrangement. A further liquid flow can be supplied via the additional bioprocess inlet. This design opens up the possibility of generating a reactive liquid flow to adjust a further parameter in a particularly simple manner without impairing the performance.

According to various embodiments, the concentrate flow is combined with the diluent flow in the expansion tank to form a first liquid flow containing a target factor and then combined with a second liquid flow in a precisely predefined volume ratio to form a third, reactive liquid flow. This simple process control makes it particularly easy to produce predefined conditions, in particular virus-inactivating or buffer-diluting conditions.

According to various embodiments, the bioprocessing system has at least one mixer for mixing the third, reactive liquid flow. This enables the homogenization of a target parameter, in particular the pH or the conductivity, in a particularly simple manner.

Various embodiments provide that the bioprocess arrangement downstream of the mixer has a dwell time arrangement for providing a minimum dwell time of a liquid flow. This dwell time arrangement ensures the required incubation time of a liquid flow, in particular with virus-inactivating agents, in a particularly simple manner.

According to various embodiments, the sensor arrangement generates process data into which liquid parameters of the first liquid flow containing a target factor and liquid parameters of the third, reactive liquid flow are incorporated. Based on an actual value for the liquid parameter determined by the measurement, the electronic process control executes a virus inactivation routine to adjust a target value for the liquid parameter, in particular a target pH or a target conductivity, in a liquid flow. This allows the continuous adjustment of an otherwise deviating value, in particular by adjusting the acid concentration or by adjusting the buffer concentration, in order to keep it as constant as possible and thus enables continuous virus inactivation or continuous inline dilution in a particularly efficient manner.

Various embodiments relate to a disposal line which is set up for discharging a liquid flow from the bioprocess arrangement. This variant offers the advantage that liquid flows or parts thereof which are not to be passed further through the bioprocess arrangement can be diverted and, in particular, discharged or disposed of from the bioprocess arrangement for further use. This enables so-called priming of the system, i.e., flooding of the line arrangement with buffer, disposal of (partial) liquid flows which are no longer required and/or the like, and generally increases the flexibility of the method according to the proposal. For these purposes, according to various embodiments, a valve arrangement with at least one valve is also provided for the selective fluidic connection of the respective line with the line arrangement.

Various embodiments relate to the embodiment of the bioprocess arrangement with a second bioprocess inlet to which a fifth delivery device is assigned, whereby a fourth, neutralizing liquid flow is introduced and combined with the third, reactive liquid flow to generate a fifth, resulting liquid flow. This offers the advantage of particularly simple neutralization of the virus-inactivating conditions in particular.

Various embodiments of delivery devices for metered delivery of a liquid flow are provided herein.

In various embodiments, the bioprocess arrangement has at least one second mixer which is set up for mixing the fifth, resulting liquid flow. This mixer makes it possible to homogenize the neutralizing conditions, in particular the pH, in a particularly simple manner and permits continuous operation of the process.

Various embodiments concern the measurement positions as well as measurement parameters of the sensors of the sensor arrangement, so that process data can be generated in a particularly simple and efficient manner. In addition, the electronic process control performs a neutralization routine to adjust a target value for a liquid parameter, in particular pH or conductivity, in a liquid flow. This allows the continuous adjustment of an otherwise deviating value, in particular by adjusting the base concentration or by adjusting the buffer concentration, in order to keep it as constant as possible and thus enables continuous virus inactivation or continuous inline dilution in a particularly efficient manner.

According to various embodiments, the electronic process control generates a second model from the process data and the degree of adjustment of the delivery rate of the fourth/and or fifth delivery device is derived from this second model. This embodiment offers the advantage that the process is not only controllable, but that this control can be carried out automatically by the underlying second model for particularly simple implementation of a continuous virus inactivation or inline dilution process.

According to various embodiments, the first model and/or the second model is a statistical or analytical model. This ensures particular flexibility in the applicability and efficiency of the proposed method.

Various embodiments concern the continuous exit of a liquid flow from the bioprocess arrangement and underpins the connectability of the method according to the proposal to a downstream, such as continuous, process in a particularly simple manner.

Various embodiments relate to the embodiment of the first and/or second mixer. In various embodiments, a centrifugal pump is used for dynamic inline mixing, through which the liquid flows in the opposite flow direction compared to the intended operation. This design makes it possible for the impeller of the centrifugal pump, which rotates in the opposite direction to the intended direction, to act as a mixer, which makes it possible to set a variable mixing capacity by regulating the speed without causing an increase in pressure in the system.

According to various embodiments, the method according to the proposal is carried out in combination with chromatography processes and/or with filtration processes. This offers the possibility of simple integration of the method according to the proposal into an already existing process.

According to various embodiments, a bioprocess arrangement for operating a continuous downstream process, in particular a continuous virus inactivation or inline dilution process, during a bioprocess is provided, wherein the bioprocess arrangement has an expansion tank, with a first fluid inlet, set up for introducing a concentrate flow, in particular a product or buffer concentrate flow, into the expansion tank, with at least one second fluid inlet, set up for introducing a diluent flow, in particular a product or buffer diluent flow, into the expansion tank, with a fluid outlet, set up for discharging a liquid flow from the expansion tank, wherein the bioprocess arrangement has a delivery device, set up for conveying a diluent flow, in particular a product or buffer diluent flow, into the expansion tank, with a fluid outlet, set up for discharging a liquid flow from the expansion tank, wherein the bioprocess arrangement has a delivery arrangement for conveying fluid, which is assigned to the first fluid inlet and the second fluid inlet for conveying at least one liquid flow into the expansion tank in each case, and to the fluid outlet for conveying a liquid flow from the expansion tank, and wherein the bioprocess arrangement has an electronic process control. Reference may be made in this respect to all explanations of the method according to the proposal for operating a continuous downstream process.

Specifically, it is proposed that during the intended operation of the bioprocess arrangement, the electronic process control adjusts a fill level in the expansion tank by open-loop and/or closed-loop control of the delivery arrangement in such a way that the fill level in the expansion tank does not fall below a predefined minimum fill level.

According to various embodiments, an electronic process control of the bioprocess arrangement according to the proposal is provided. Reference may be made in this respect to all explanations of the method according to the proposal for operating a continuous downstream process and of the bioprocess arrangement according to the proposal.

According to various embodiments, the electronic process control comprises a data processing system for realizing a method according to the proposal.

According to various embodiments, the use of an electronic process control for implementing a method according to the proposal is provided. Reference may be made in this respect to all explanations relating to the method according to the proposal for operating a continuous downstream process, to the bioprocess arrangement according to the proposal and to the electronic process control according to the proposal.

According to various embodiments, a computer program for the electronic process control according to the proposal is provided. Reference may be made in this respect to all explanations relating to the proposed method for operating a continuous downstream process, to the proposed bioprocess arrangement, to the proposed electronic process control and to the proposed use.

According to various embodiments, a computer-readable storage medium for storing the computer program according to the proposal is provided. Reference may be made in this respect to all explanations of the method according to the proposal for operating a continuous downstream process, the bioprocess arrangement according to the proposal, the electronic process control according to the proposal, the use according to the proposal and the computer program according to the proposal.

Various embodiments provide a method for operating a continuous downstream process, in particular a continuous virus inactivation or inline dilution process, during a bioprocess using a bioprocess arrangement, wherein the bioprocess arrangement comprises an expansion tank with a first fluid inlet, set up for introducing a concentrate flow, in particular a product or buffer concentrate flow, into the expansion tank, with at least one second fluid inlet, set up for introducing a diluent flow, in particular a product or buffer diluent flow, into the expansion tank, with a fluid outlet, set up for discharging a liquid flow from the expansion tank, the bioprocess arrangement having a delivery arrangement for conveying fluid, which is associated with the first fluid inlet and the second fluid inlet for conveying in each case at least one liquid flow into the expansion tank, and with the fluid outlet for conveying a liquid flow out of the expansion tank, and the bioprocess arrangement having an electronic process control, wherein the electronic process control adjusts a fill level in the expansion tank by open-loop and/or closed-loop control of the delivery arrangement in such a way that the fill level in the expansion tank does not fall below a predefined minimum fill level.

In various embodiments, the electronic process control adjusts the fill level in the expansion tank by open-loop and/or closed-loop control of the delivery arrangement in such a way that a predefined target fill level is reached or the fill level is maintained in a target fill level range.

In various embodiments, the delivery arrangement has a first delivery device for conveying fluid, which is assigned to the first fluid inlet, and/or the delivery arrangement has a second delivery device for conveying fluid, which is assigned to the second fluid inlet, and/or the delivery arrangement has a third delivery device for conveying fluid, which is assigned to the fluid outlet.

In various embodiments, the bioprocess arrangement has a bioprocess outlet which is set up for discharging a fluid from the bioprocess arrangement, the bioprocess arrangement has a line arrangement with at least one line for fluidic connection of the fluid outlet of the expansion tank to the bioprocess outlet, and the third delivery device is set up for conveying fluid through the at least one line of the line arrangement.

In various embodiments, the bioprocess arrangement has a sensor arrangement for generating process data, with at least one sensor assigned to the expansion tank, and the electronic process control derives an actual value for a filling level parameter in the expansion tank from the process data in a monitoring routine, and depending on a deviation between the derived actual value for the filling level parameter and a predefined minimum value for the filling level parameter corresponding to the predefined minimum filling level in the expansion tank, adjusts the delivery rate of the first, second and/or third delivery device to prevent the filling level from falling below the minimum filling level or depending on a deviation between the derived actual value for the filling level parameter and a predefined target value for the filling level parameter corresponding to the predefined target filling level in the expansion tank, adjusts the delivery rate of the first, second and/or third delivery device to achieve the target filling level or adjusts the delivery rate of the first, second and/or third delivery device to maintain the fill level in the target fill level range as a function of a deviation between the derived actual value for the fill level parameter and a predefined limit value of the predefined target fill level range in the expansion tank.

In various embodiments, the electronic process control generates a first model from the process data, and the degree of adjustment of the delivery rate of the delivery arrangement is derived from the first model. In some embodiments, the first model represents the dependency between the filling level parameter in the expansion tank on the one hand and the delivery rate of the first, second and/or third delivery device on the other hand.

In various embodiments, the bioprocess arrangement has a first bioprocess inlet downstream of the expansion tank, set up for introducing a liquid flow into the line arrangement of the bioprocess arrangement, and the delivery arrangement has a fourth delivery device which is assigned to the first bioprocess inlet and is set up for metered delivery of a liquid flow into the line arrangement.

In various embodiments, the concentrate flow is combined with the diluent flow in the expansion tank to form a first liquid flow containing a target factor, and the first liquid flow containing a target factor is introduced through the fluid outlet from the expansion tank into the at least one fluidically connected line of the line arrangement and is combined in a predefined volume ratio with a second liquid flow, which can be introduced through the first bioprocess inlet and conveyed by the fourth delivery device, to form a third, reactive liquid flow, in order to set a predefined target value for a liquid parameter, in particular for a pH and/or a conductivity, in the third, reactive liquid flow.

In various embodiments, the bioprocess arrangement has, in some embodiments downstream of the first bioprocess inlet, a first mixer set up for fluid mixing, and the third, reactive liquid flow is passed through the first mixer for fluid mixing.

In various embodiments, the bioprocess arrangement has, in some embodiments downstream of the at least one mixer, a dwell time arrangement fluidically connected to the first mixer for providing a minimum dwell time of a liquid flow, and the third, reactive liquid flow is passed through the dwell time arrangement downstream of the at least one mixer for providing a minimum dwell time.

In various embodiments, the sensor arrangement for generating the process data comprises at least one sensor for measuring a liquid parameter of the first liquid flow containing a target factor, in particular a pH and/or a conductivity, and at least one sensor, such as at least two sensors, for measuring a liquid parameter of the third, reactive liquid flow, in particular a pH and/or a conductivity, which can be arranged downstream of the first mixer and/or the dwell time arrangement.

In various embodiments, the electronic process control in a virus inactivation routine, depending on a deviation between an actual value determined by the measurement for the liquid parameter of the first liquid flow containing a target factor and the predefined target value for the liquid parameter in the third, reactive liquid flow, adjusts the delivery rate of the fourth delivery device for setting the target value for the liquid parameter in the third, reactive liquid flow.

In various embodiments, the line arrangement has, in some embodiments downstream of the dwell time arrangement, a disposal line which is set up for discharging a liquid flow from the bioprocess arrangement.

In various embodiments, the line arrangement is assigned a valve arrangement with at least one valve for the selective fluidic connection of at least one line of the line arrangement, in particular the disposal line.

In various embodiments, the bioprocess arrangement has, in some embodiments downstream of the disposal line, a second bioprocess inlet, set up for introducing a liquid flow into the line arrangement of the bioprocess arrangement, the delivery arrangement has a fifth delivery device, which is assigned to the second bioprocess inlet and is set up for metered delivery of a liquid flow into the line arrangement, and in some embodiments the third, reactive liquid flow is combined downstream of the dwell time arrangement with a fourth, neutralizing liquid flow introduced through the second bioprocess inlet to form a fifth, resulting liquid flow in order to neutralize the predefined liquid parameter in the fifth, resulting liquid flow.

In various embodiments, the respective delivery device, in some embodiments all delivery devices which are set up for the metered delivery of a liquid flow, are designed as a metering pump, in particular as a peristaltic pump, rotary piston pump or diaphragm pump, or as a valve, in particular a continuous valve, control valve or the like.

In various embodiments, the bioprocess arrangement comprises, in some embodiments downstream of the second bioprocess inlet, at least one second mixer, set up for fluid mixing, and the fifth, resulting liquid flow is passed through the second mixer for fluid mixing.

In various embodiments, the sensor arrangement for generating the process data has at least one sensor for measuring a liquid parameter of the fifth, resulting liquid flow, in particular a pH and/or a conductivity, in some embodiments downstream of the second mixer, and the electronic process control in a neutralization routine adjusts the delivery rate of the fifth delivery device for setting the target value for the liquid parameter in the fifth, resulting liquid flow as a function of a deviation between an actual value, determined by the measurement, for the liquid parameter of the third, reactive liquid flow and a predefined target value for the liquid parameter in the fifth, resulting liquid flow.

In various embodiments, the respective sensor for generating the process data measures at least one parameter from the group comprising pH value, conductivity, filling level, change in filling level per time, delivery rate of at least one delivery device, flow rate of at least one liquid flow, protein concentration and/or other spectrophotometric properties of at least one liquid flow.

In various embodiments, the electronic process control generates a second model from the process data, the degree of adjustment of the delivery rate of the fourth and/or fifth delivery device is derived from the second model, in some embodiments the second model describes the dependence between the liquid parameter of the third, reactive liquid flow on the one hand and the delivery rate of the fourth delivery device on the other hand, and/or the second model represents the dependence between the liquid parameter of the fifth, resulting liquid flow on the one hand and the delivery rate of the fifth delivery device on the other hand.

In various embodiments, the first model and/or the second model is a statistical model or an analytical model.

In various embodiments, the liquid flow discharged from the bioprocess arrangement, in some embodiments the third, reactive liquid flow or the fifth, resulting liquid flow, leaves the bioprocess arrangement continuously.

In various embodiments, at least the first and/or second mixer, in some embodiments all mixers, are set up for inline mixing of a liquid flow and are designed as static mixers or as centrifugal pumps, in particular centrifugal rotatory pumps. In some embodiments, the centrifugal pump for dynamic inline mixing is passed through in the opposite flow direction compared to the intended operation.

In various embodiments, the method according to the proposal is carried out in combination with an upstream, in some embodiments discontinuous or continuous, chromatography process and/or filtration process, and/or a continuous chromatography or filtration process is connected downstream of the method according to the proposal.

Various embodiments provide a bioprocess arrangement for operating a continuous downstream process, in particular a continuous virus inactivation or inline dilution process, during a bioprocess, the bioprocess arrangement having an expansion tank with a first fluid inlet, set up to introduce a concentrate flow, in particular a product or buffer concentrate flow, into the expansion tank, with at least one second fluid inlet, set up to introduce a diluent flow, in particular a product or buffer diluent flow, into the expansion tank, with a fluid outlet, set up for discharging a liquid flow from the expansion tank, the bioprocess arrangement having a delivery arrangement for conveying fluid, which is assigned to the first fluid inlet and the second fluid inlet for conveying at least one liquid flow into the expansion tank in each case, and to the fluid outlet for conveying a liquid flow out of the expansion tank, and wherein the bioprocess arrangement has an electronic process control, wherein during the intended operation of the bioprocess arrangement, the electronic process control adjusts a fill level in the expansion tank by open-loop and/or closed-loop control of the delivery arrangement in such a way that the fill level in the expansion tank does not fall below a predefined minimum fill level.

Various embodiments provide an electronic process control of the bioprocess arrangement, wherein the line arrangement is assigned a valve arrangement with at least one valve for selective fluidic connection of the at least one line, in some embodiments all lines, of the line arrangement, the electronic process control controls at least the delivery arrangement or additionally the valve arrangement, and the electronic process control is set up to carry out a method as described herein by open-loop and/or closed-loop control of at least the delivery arrangement.

In various embodiments, the electronic process control comprises a data processing system for realizing a method as described herein.

Various embodiments provide the use of an electronic process control as described herein for implementing a continuous downstream method as described herein.

Various embodiments provide a computer program for the electronic process control as described herein.

Various embodiments provide a computer-readable storage medium on which the computer program as described herein is stored, such as in a non-volatile manner.

### BRIEF DESCRIPTION OF THE DRAWINGS

In the following, various aspects are explained in greater detail with the aid of a drawing showing only exemplary embodiments. The drawing shows in

FIG. 1 an exemplary embodiment of a proposed method for operating a continuous downstream process,

FIG. 2 a further exemplary embodiment of a method according to the proposal for operating a continuous downstream process, in particular a continuous virus inactivation process,

FIG. 3 a flow chart showing an operating principle of the proposed method according to FIG. 1.

### DETAILED DESCRIPTION

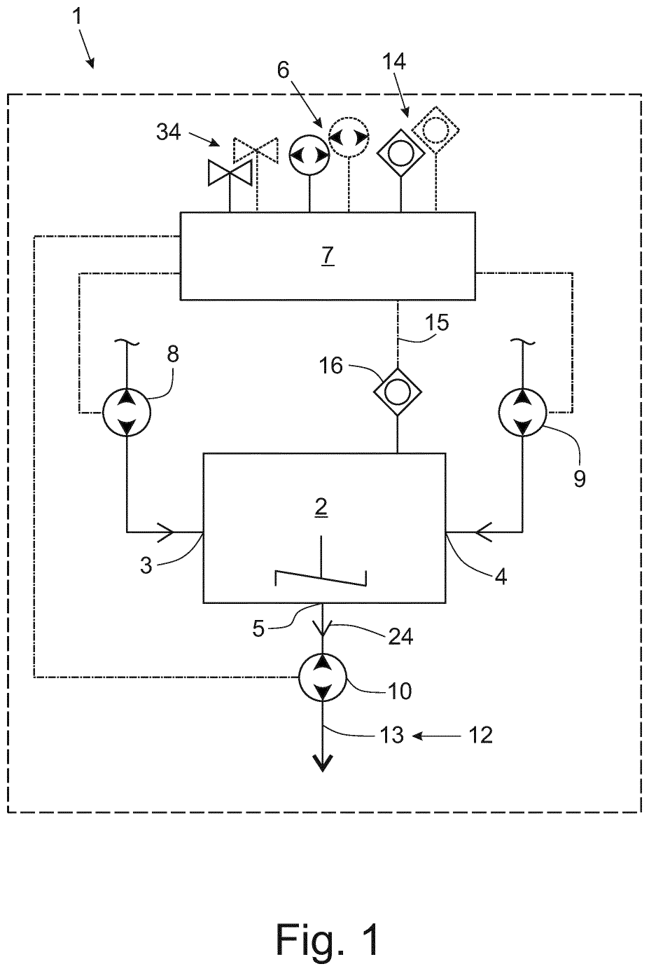

FIG. 1 shows a proposed method for operating a continuous downstream process, in particular a continuous virus inactivation or inline dilution process. This is used in the downstream process of a bioprocess using a bioprocess assembly 1, in particular in the production, purification and/or quality control of biopharmaceutical products, such as during the production of a protein. Such proteins may be growth factors, hormones, enzymes and in particular antibodies, antibody derivatives or the like. The method according to the proposal can be used to ensure that a biopharmaceutical product does not contain active viral particles of any type above a certain threshold set by, for example, the manufacturer and/or regulatory authorities, etc., in particular no active viral particles at all. Alternatively, the method according to the proposal can be used for continuous in-line dilution, in particular of buffers.

The target protein may originate either directly or indirectly from a bioreactor, in particular after processing steps, in particular downstream processing steps such as filtration, precipitation, and/or chromatographic separation steps or the like, have been carried out.

Such chromatographic steps may be, for example, affinity chromatographic steps, in particular affinity chromatographic steps using protein A.

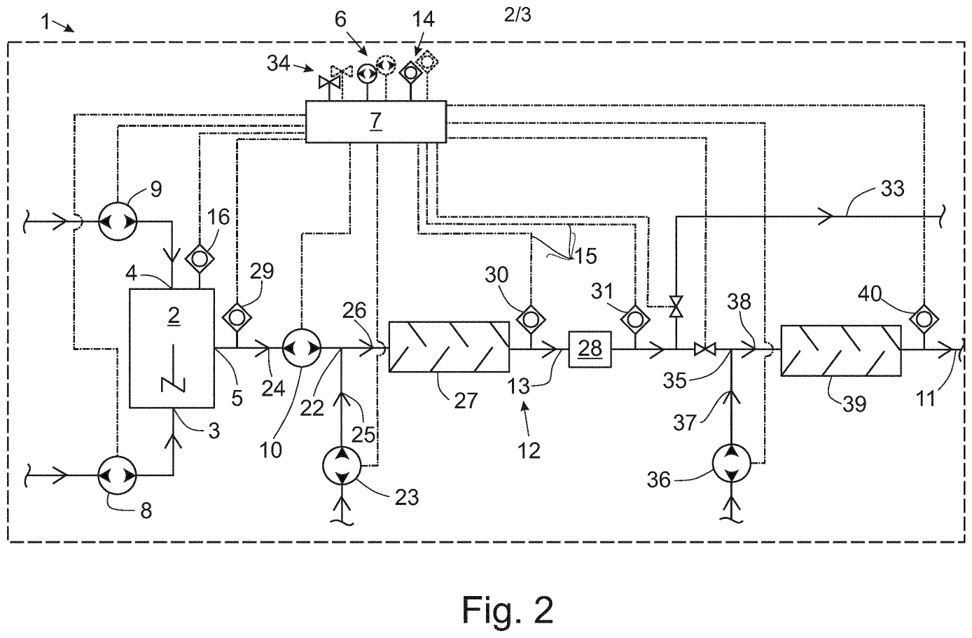

The bioprocess arrangement 1 has an expansion tank 2 with a first fluid inlet 3, set up for introducing a concentrate flow, in particular a product or buffer concentrate flow, into the expansion tank 2, and with at least one second fluid inlet 4, set up for introducing a diluent flow, in particular a product or buffer diluent flow, into the expansion tank 2. The expansion tank 2 can be an agitated expansion tank 2, as shown in FIG. 1 and FIG. 2, and is therefore set up for homogenization.

The term “product concentrate flow” here means a liquid flow that substantially contains product from an upstream process step, in particular eluate from an upstream chromatography step.

The term “buffer concentrate flow” here means a liquid flow that substantially contains buffers, in particular a concentrated buffer that is diluted inline for further use in the bioprocess.

The term “product diluent flow” here means a liquid flow that substantially contains solvent that is set up to dilute a product from an upstream process step, in particular buffers that are suitable for the respective product.

The term “buffer diluent flow” here means a liquid flow that substantially contains a solvent that is used to dilute a buffer, in particular water.

The bioprocess arrangement 1 has a fluid outlet 5, set up for discharging a liquid flow from the expansion tank 2. Furthermore, the bioprocess arrangement 1 has a delivery arrangement 6 for conveying fluid, which is assigned to the first fluid inlet 3 and the second fluid inlet 4 for conveying at least one liquid flow into the expansion tank 2 in each case, and to the fluid outlet 5 for conveying a liquid flow out of the expansion tank 2. In addition, the bioprocess arrangement 1 has an electronic process control 7.

The term “conveying fluid” is to be understood broadly here and means any type of conveyance and/or adaptation, in particular interruption, of the conveyance of fluids, in particular liquids.

A key feature of the proposed method is that the electronic process control 7 adjusts the fill level in the expansion tank 2 by open-loop and/or closed-loop control of the delivery arrangement 6 in such a way that the fill level in the expansion tank 2 does not fall below a predefined minimum fill level. This ensures a continuous liquid flow that can be discharged from the bioprocess arrangement 1 (FIG. 1).

The term “minimum fill level” is to be understood broadly in the present case and can mean any type of fill level in the expansion tank that has been defined, such as by a user, as the minimum fill level. According to various embodiments, the minimum fill level can be less than 50%, less than 25%, less than 10%, or less than 5% of the total volume of the expansion tank 2.

In various embodiments, the electronic process control 7 adjusts a fill level in the expansion tank 2 by open-loop and/or closed-loop control of the delivery arrangement 6 in such a way that a predefined target fill level is reached or that the fill level is maintained in a target fill level range.

The term “target level” here means any level that is defined, such as by the user, as the fill level to be reached. A “target fill level range” is a range between an upper limit and a lower limit for the fill level, within which the fill level is maintained.

In various embodiments,, the delivery arrangement 6 has a first delivery device 8 for conveying fluid, which is assigned to the first fluid inlet 3. In addition or alternatively, the delivery arrangement 6 can have a second delivery device 9 for conveying fluid, which is assigned to the second fluid inlet 4. Further additionally or alternatively, the delivery arrangement 6 can have a third delivery device 10 for conveying fluid, which is assigned to the fluid outlet 5.

The bioprocess arrangement 1 can have a bioprocess outlet 11 which is set up to discharge a liquid from the bioprocess arrangement 1. Furthermore, the bioprocess arrangement 1 has a line arrangement 12 with at least one line 13 for fluidic connection of the fluid outlet 5 of the expansion tank 2 to the bioprocess outlet 11. This discharge from the bioprocess outlet 11 can take place when a liquid flow has passed through the method according to the proposal and is passed to a downstream process step, such as a downstream chromatography step or the like, for further processing.

The third delivery device 10 can be, as can be seen in FIG. 1 and FIG. 2, set up for conveying fluid through the at least one line 13 of the line arrangement 12.

Furthermore, the bioprocess arrangement 1 has a sensor arrangement 14 for generating process data 15, with at least one sensor 16 assigned to the expansion tank 2.

The at least one sensor 16 in the expansion tank 2 can be designed as a fill level sensor, which is, further, set up to measure a fill level and/or to measure a change in a fill level per unit of time. In various embodiments, the fill level sensor is set up to measure a fill level parameter.

The term “fill level parameter” is to be understood here in a broad sense. In various embodiments, the fill level parameter is generally a measure of the filling of the expansion tank 2 with liquid and can be represented by a percentage filling of the expansion tank 2, a certain mass, a certain volume, a certain concentration or the like. In addition, the fill level parameter can be represented by a specific level at a specific time or as a change in level over time, which can also represent the flow rate.

The term “liquid” is also to be understood in a broad sense. It includes not only a pure liquid as such, but also emulsions and suspensions, e.g., a heterogeneous mixture of at least two different liquids or a heterogeneous mixture consisting of solid parts and liquid.

Additionally or alternatively, the at least one sensor 16 in the expansion tank 2 can be designed as a force sensor, such as a load cell, which, can be set up to measure a force, in particular a mass and/or to measure a change in a mass per unit of time. In various embodiments, this force, in particular the mass and/or the change in a mass per unit of time, can be converted into a fill level and/or into the change in a fill level per unit of time.

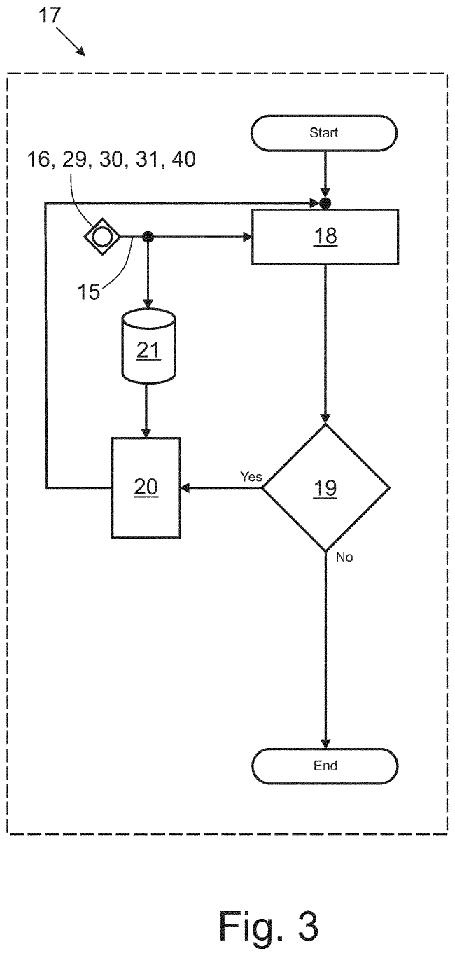

In various embodiments, the electronic process control 7 derives at least one actual value for a fill level parameter in the expansion tank 2 from the process data 15 in a monitoring routine 17, such as in an information query 18. Depending on a deviation, such as determined at a decision point 19, between the derived actual value for the fill level parameter and a predefined minimum value for the fill level parameter corresponding to the predefined minimum fill level in the expansion tank 2, the electronic process control 7 adjusts, such as in an adjustment step 20, the delivery rate of the first, second and/or third delivery device 8, 9, 10 to prevent the fill level from falling below the minimum fill level, as shown in FIG. 3.

Alternatively, depending on a deviation between the derived actual value for the fill level parameter and a predefined target value for the fill level parameter corresponding to the predefined target fill level in the expansion tank 2, the electronic process control 7 adjusts the delivery rate of the first, second and/or third delivery device 8, 9, 10 to achieve the target fill level.

Alternatively, depending on a deviation between the derived actual value for the fill level parameter and a predefined limit value of the predefined target fill level range in the expansion tank 2, the electronic process control 7 adjusts the delivery rate of the first, second and/or third delivery device 8, 9, 10 to maintain the fill level in the target fill level range.

The term “deviation” is to be understood broadly here and includes not only any subtraction between a measured value and a target value, but also any other type of mathematical deviation including a variance, a difference and/or an integral of a difference or the like.

In various embodiments, the delivery rate of at least the first and/or second delivery device 8, 9 is adjusted, in some embodiments increased, in the adjustment step 20. Additionally or alternatively, the delivery rate of at least the third delivery device 10 can be adjusted, such as reduced.

If now, as shown in FIG. 1, the electronic process control 7 in the monitoring routine 17 derives a fill level parameter in the expansion tank 2 from the process data 15 and detects a deviation from a predefined target fill level in the expansion tank 2, the electronic process control 7 can adjust the delivery rate of at least the first and/or second delivery device 8, 9, and in some embodiments this can be increased. As a result, more liquid is dispensed into the expansion tank 2 so that a continuous liquid flow flowing out of the expansion tank 2 can be maintained. In various embodiments, the liquid flow fed into the expansion tank 2 to achieve a predefined target fill level is the concentrate flow and/or the diluent flow. For this reason, it can be that the supply of a liquid flow to maintain a continuous liquid flow flowing out of the expansion tank 2 does not exceed a level which would result in the concentration in the expansion tank 2 falling below a target factor concentration, unless the continuous liquid flow flowing out of the expansion tank 2 would otherwise come to a standstill.

The term “target factor” here means a product, such as an eluate, or a buffer. Similarly, the term “target factor concentration” here means a product concentration, such as an eluate concentration, or a buffer concentration. It should be noted that, as already indicated above, the supply of a liquid flow into the expansion tank 2 does not exceed a level below a, such as predefined, product concentration, such as eluate concentration, or a, in some embodiments predefined, buffer concentration. This can be set by the user of the method according to the proposal before and/or during the process for operating a continuous downstream process.

In addition or alternatively, the delivery rate can be adapted at least to the third delivery device 10, and further in some embodiments reduced. This in turn has the consequence that the flow rate of the liquid flow flowing out of the expansion tank 2 is reduced, but a continuous liquid flow flowing out of the expansion tank 2 can be maintained as a result. It can be that, in order to maintain a continuous flow, the delivery rate of at least the first and/or second delivery device 8, 9 is initially adjusted, and in some embodiments increased.

The delivery rate of at least the third delivery device 10 can be adjusted if the adjustment of the delivery rate of at least the first and/or second delivery device 8, 9 is not sufficient to maintain a continuous liquid flow. In various embodiments, the delivery rate of the third delivery device 10 is kept substantially constant. Otherwise, a changing flow rate would result in the dwell time of a liquid flow in the bioprocess arrangement 1, which is described in greater detail later, falling below a predefined minimum dwell time.

In various embodiments, as FIGS. 1, 2 and 3 show, the electronic process control 7 generates a first model 21 from the process data 15. A model here always refers to a mathematical model. The degree of adjustment of the delivery rate of the delivery arrangement 6 can be derived from the first model 21. The first model 21 represents, in some embodiments, the dependency between the filling level parameter, such as the change in the target filling level per time, in the expansion tank 2 on the one hand and the delivery rate of the first, second and/or third delivery device 8, 9, 10 on the other hand. In various embodiments, the first model 21 is set up to predict future target fill levels, such as at a predefined time, in the expansion tank 2 as a function of the change in the target fill level per time.

In various embodiments, as FIG. 2 shows, the bioprocess arrangement 1 has a first bioprocessing inlet 22 downstream of the expansion tank 2, which is set up to introduce a liquid flow into the line arrangement 12 of the bioprocess arrangement 1. This can be located downstream of the third delivery device 10. The delivery arrangement 6 can have a fourth delivery device 23, which is assigned to the first bioprocess inlet 22 and is set up for metered delivery of a liquid flow into the line arrangement 12.

The concentrate flow can be combined in the expansion tank 2 with the diluent flow to form a first liquid flow 24 containing a target factor. This first liquid flow 24 containing a target factor can contain as target factor either the biopharmaceutical target product, such as an antibody or a vector, as well as process-related viruses. Alternatively, this first liquid flow 24 can contain as target factor a target buffer, such as an equilibration, washing or elution buffer or the like. In this respect, the term “target factor” thus means a specific property of the liquid of the liquid flow 24, as already mentioned above.

The first liquid flow 24 containing a target factor can be introduced through the fluid outlet 5 from the expansion tank 2 into the at least one fluidically connected line 13 of the line arrangement 12. This can then be combined in a predefined volume ratio with a second liquid flow 25 introduced through the first bioprocess inlet 22 and conveyed by the fourth delivery device 23 to form a third, reactive liquid flow 26, in order to set a predefined target value for a liquid parameter, in particular for a pH and/or a conductivity, in the third, reactive liquid flow 26.

The second liquid flow 25 either has virus-inactivating conditions, in particular a pH of less than 3, as a property necessary to fulfill the intended function. The virus-inactivating conditions, in particular the pH, of the second liquid flow 25 are selected such that, after merging with the first liquid flow 24 containing a target factor, the resulting third, reactive liquid flow 26 also has virus-inactivating conditions, in particular a pH of 3 to 3.8 and/or a detergent concentration of between 0.05% and 10% (v/v). Such conditions lead to effective virus inactivation without damaging the respective product of the bioprocess, in particular proteins. The pH is achieved by adding an acid such as lactic acid, ascorbic acid, acetic acid, hydrochloric acid, phosphoric acid, citric acid, glycine, succinic acid and/or sulphuric acid or the like. In various embodiments, the virus-inactivating reagent may comprise an acid having a titratable group with a pKs between 2.0 and 4.3. The virus-inactivating conditions can be chosen such that the concentration of the acid can be up to 100 mM and still have sufficient buffering properties to enable effective virus inactivation on the one hand and not to damage the protein product on the other hand, e.g., by acid denaturation. Additionally or alternatively, the virus-inactivating conditions can be generated by a non-ionic detergent which has a chromophoric group. Such detergents can be, for example, Triton-X 100 and other polyethylene oxides.

The virus-inactivating conditions can be selected with the method according to the proposal such that virus inactivation can be realized by a factor of at least 1×10¹, at least 1×10³, or at least 1×10⁶, in particular irrespective of whether exactly one specific virus type, several virus types and/or a plurality of different virus types are involved. The virus-inactivating conditions can be selected such that less than 1 ppm or less than 1 ppb, of the volume of the third, reactive liquid flow 26 has a dwell time which is shorter than that which would be necessary for effective virus inactivation by a factor of at least 1×10¹, in particular of at least 1×10⁶.

As shown in FIG. 2, the second liquid flow 25 can be mixed for virus inactivation with the first liquid flow 24 containing a target protein in a precisely predefined volume ratio of these two liquid flows 24, 25 to one another, so that it can be ensured that the conditions in the third, reactive liquid flow 26 are actually present and homogeneously distributed in order to fulfill the intended function. Such a volume ratio can, for example, be 19:1, with nineteen portions of the first liquid flow 24 containing a target protein and one portion of the second, virus-inactivating liquid flow 25.

Alternatively, the second liquid flow 25 has buffer-diluting conditions as a property necessary to fulfill the intended function, in some embodiments that the second liquid flow 25 consists of dilution buffer and/or water or the like. In this alternative, the buffer-diluting conditions of the second liquid flow 25 are selected such that after merging with the first liquid flow 24 comprising a target factor, the resulting third, reactive liquid flow 26 also has buffer-diluting conditions, in particular a target buffer concentration. The dilution to produce a target buffer concentration is achieved by adding a dilution buffer and/or water or the like.

In various embodiments, the bioprocess arrangement 1 has, in some embodiments downstream of the first bioprocessing inlet 22, a first mixer 27, set up for fluid mixing. The third, reactive liquid flow 26 can be passed through the first mixer 27 for fluid mixing. This mixer 27 can be designed as an inline static mixer, in particular as a radial or laminar static mixer or the like, as shown in FIG. 2. In various embodiments, depending on the process or accuracy requirements, a plurality of static mixers can be connected in series. Additionally or alternatively, a dynamic mixer can also be provided as the first mixer 27.

The term “fluid mixing” is to be understood broadly here and means any type of mixing of a fluid, in particular a liquid, which goes beyond simply passing the fluid through a line, in particular a hose or pipe line.

In various embodiments, the bioprocess arrangement 1 has, in some embodiments downstream of the first mixer 27, a dwell time arrangement 28 fluidically connected to the first mixer 27 for providing a minimum dwell time of a liquid flow (see FIG. 2). The third, reactive liquid flow 26 can be passed through the dwell time arrangement 28 to provide a minimum dwell time.

The above-described supply of a liquid flow into the expansion tank 2 to maintain a continuous liquid flow causes the concentration in the expansion tank 2, such as the product concentration or buffer concentration, to change. Both parameters can have an influence on a logarithmic reduction of the viral load, so that the dwell time of the liquid flow in the dwell time arrangement 28 is at least 15 minutes, such as up to 1 h, so that such changes also remain uncritical.

The term “fluidic connection” here means a tight connection that allows a fluid to pass internally from one area to another, at least unidirectionally, in some embodiments bidirectionally. In this case, the fluidic connection is also released by mechanical loosening.

“Dwell time arrangement” here means an arrangement which, in the intended assembled state, serves to allow a certain volume flow, consisting of one or more combined fluid flows, in particular liquid flows, to “dwell” within this arrangement by designing the dwell time arrangement 28 in such a way that the distance to be covered by the volume flow is artificially extended so that a multiple distance must be covered relative to the extension of the component. As already explained above, it is crucial that the distribution of the dwell times of the individual volume fractions to be inactivated must be as uniform as possible in order to obtain a reproducible inactivation result.

In various embodiments, the sensor arrangement 14 for generating the process data 15 has at least one sensor 29 for measuring a liquid parameter, in particular a pH and/or a conductivity, of the first liquid flow 24 containing a target factor, which can be designed as a pH sensor and is set up for measuring a pH in the first liquid flow 24 containing a target factor. Alternatively, the sensor 29 can be configured as a conductivity sensor, which can be configured to measure a conductivity in the first liquid flow 24 containing a target factor. The sensor 29 can be arranged downstream of the expansion tank 2 and upstream of the first bioprocess inlet 22 (FIG. 2).

In addition, the sensor arrangement 14 can have at least one sensor 30, 31, in some embodiments at least two sensors 30, 31, for measuring a liquid parameter, in particular a pH and/or a conductivity, of the third, reactive liquid flow 26. The sensor 30 can be arranged downstream of the first mixer 27. Additionally or alternatively, the sensor arrangement 14 can have downstream of the dwell time arrangement 28 at least one sensor 31 for measuring a liquid parameter in the third, reactive liquid flow 26. The sensor 31 is used in particular to measure a flow rate and/or a protein concentration, such as by means of UV measurement.

The measurement of the flow rate can be used for a particularly precise determination of the required dwell time of the third, reactive liquid flow 26 in the dwell time arrangement 28. This is due to the fact that, as already discussed above, a changing flow rate has the consequence that the dwell time of a liquid flow in the dwell time arrangement 28 required for the intended process also changes. Thus, the dwell time of a liquid flow in the dwell time arrangement 28 can be set by adjusting the flow velocity.

The measurement of the UV absorption can be used for a particularly precise determination of the target factor concentration, in particular a protein concentration. Depending on whether the protein concentration falls below a, such as predefined, minimum protein concentration, the electronic process control 7 can control the delivery arrangement 6 in such a way that the flow direction of the third, reactive liquid flow 26 can be diverted via a line 13 of the line arrangement 12, which is described in greater detail later, and the third, reactive liquid flow 26 can be continuously forwarded to a subsequent process step or disposed of in a subsequent disposal step. This can be the case if the protein concentration has fallen below a predetermined minimum protein concentration, as it would otherwise not be economical to continue virus inactivation of the product. A predetermined minimum protein concentration can be fallen below in particular at the beginning (during or immediately after the so-called priming) or towards the end of a continuous downstream process, in particular a continuous virus inactivation process.

The electronic process control 7 can adjust the delivery rate of the fourth delivery device 23 in a virus inactivation routine 32 to set the target value for the liquid parameter in the third, reactive liquid flow 26. This can be done as a function of a deviation between an actual value determined by the measurement for the liquid parameter of the first liquid flow 24 containing a target factor and the predefined target value for the liquid parameter in the third, reactive liquid flow 26.

The conductivity can enable the electronic process control 7 to derive a buffer concentration. If, according to this exemplary embodiment, the actual pH in the first liquid flow 24 containing a target protein deviates from the target value of the liquid parameter in the third, reactive liquid flow 26, it can be possible for the electronic process control 7 to adjust the actual value of the liquid parameter, such as the actual pH or the actual conductivity, in the third, reactive liquid flow 26 by open-loop and/or closed-loop control of the fourth delivery device 23, which can be set up for the metered delivery of acid, buffer and/or water.

By measuring the pH, the actual pH in the first liquid flow 24 containing a target factor can thus can be determined on the one hand and, on the other hand, the electronic process control 7 can calculate the volume and/or volume flow required to achieve the target value of the liquid parameter in the third, reactive liquid flow 26, in particular the target pH, on the basis of the process data 15.

Alternatively, by measuring the conductivity, the actual conductivity in the first liquid flow 24 containing a target factor can be determined on the one hand and, on the other hand, the electronic process control 7 can calculate the volume and/or volume flow required to achieve the target value for the liquid parameter in the third, reactive liquid flow 26, in particular the target conductivity, on the basis of the process data 15.

In addition, the line arrangement 12 has, in some embodiments downstream of the dwell time arrangement 28, a disposal line 33 which is set up for discharging a liquid flow from the bioprocess arrangement 1.

“Disposal line” here means a line 13 of the line arrangement 12 for establishing a fluidic connection, wherein this offers the user of the method according to the proposal the possibility of directing liquid flows introduced into the bioprocess arrangement 1 not necessarily to the bioprocess outlet 11 and out of it. This is particularly advantageous if the bioprocess arrangement 1 is rinsed with, for example, buffer before a continuous downstream method according to the proposal, in particular in a first continuous downstream method according to the proposal with a new buffer used and/or with a new concentrate flow used, in particular a new product or buffer concentrate flow.

Additionally or alternatively, this is the case if the method according to the proposal is used for a continuous inline dilution process and the third, reactive liquid flow 26 can already have the desired, predefined target value for the liquid parameter in the third, reactive liquid flow 26 and thus represents the final diluted buffer. In this case, this finally diluted buffer can be continuously discharged from the bioprocess arrangement 1 through the disposal line 33 and used directly in a downstream process step, in particular in a downstream chromatography step.

In various embodiments, the line arrangement 12 is assigned a valve arrangement 34 with at least one valve for selective fluidic connection of at least one line 13 of the line arrangement 12, in particular the disposal line 33.

In various embodiments, the bioprocess arrangement 1 has, in some embodiments downstream of the disposal line 33, a second bioprocessing inlet 35 which is set up to introduce a liquid flow into the line arrangement 12 of the bioprocess arrangement 1. The delivery arrangement 6 can have a fifth delivery device 36. This can be assigned to the second bioprocess inlet 35 and is set up for metered delivery of a liquid flow into the line arrangement 12.

According to FIG. 2, the third, reactive liquid flow 26 is combined, in some embodiments downstream of the dwell time assembly 28 with a fourth, neutralizing liquid flow 37 introduced through the second bioprocess inlet 35 to form a fifth, resultant liquid flow 38 to neutralize the predefined target value for the liquid parameter in the fifth, resultant liquid flow 38.

“Neutralizing” here means the partial or complete reversal of the previous change in the liquid parameter and thereby abolishing and/or removing the virus-inactivating conditions, in particular by the reaction of equal amounts of acids, for example 1.5 to 3 M acetic acid, or acid derivatives, for example 2 M glycine, and bases, for example 1 to 2 M HEPES pH 8 or Tris pH 11. This fourth, neutralizing liquid flow 37 serves to neutralize, deplete and/or remove the virus-inactivating conditions. By combining the third and fourth liquid flows 26, 37, a fifth resulting liquid flow 38 is formed which can be discharged from the bioprocess arrangement 1 through the bioprocess outlet 11 and has a pH, such as a pH between 5 and 8.5, which allows further processing. In various embodiments, the mixing of these two liquid flows 26, 37 also takes place in a precisely predefined volume ratio, so that it can be ensured that the neutralizing conditions in the fifth, resulting liquid flow 38 are actually present and homogeneously distributed in order to fulfill the intended function.

In various embodiments, the introduction of a fourth, neutralizing liquid flow 37 is optional in a continuous inline dilution process. In the event that the buffer needs to be further diluted to achieve the predefined conditions, additional diluting buffer, water or the like can be added to the third, reactive liquid flow 26 through the second bioprocess inlet 35. Alternatively, if the predefined conditions have already been reached, nothing can be added such that the third, reactive liquid flow 26 leaves the bioprocess arrangement 1 through the bioprocess outlet 11.

In various embodiments, the respective delivery device (8, 9, 23, 36), in particular all delivery devices which are set up for the metered delivery of a liquid flow, is designed as a metering pump, such as a peristaltic pump, rotary piston pump or diaphragm pump, or as a valve, in particular a continuous valve, control valve or the like.

The bioprocess arrangement 1 has, in some embodiments downstream of the second bioprocess inlet 35, at least one second mixer 39, set up for fluid mixing. The fifth, resulting liquid flow 38 can be passed through the at least second mixer 39 for fluid mixing and is discharged from the bioprocess arrangement 1 through the bioprocess outlet 11 after fluid mixing has been completed. This second mixer 39 can also be designed as an inline static mixer, in particular as a radial or laminar static mixer or the like, as shown in FIG. 2. In various embodiments, depending on the process or accuracy requirements, a plurality of static mixers can be connected in series. Additionally or alternatively, a dynamic mixer can also be provided as the second mixer 39.

In various embodiments, the sensor arrangement 14 for generating the process data 15 has at least one sensor 40 for measuring a liquid parameter of the fifth, resulting liquid flow 38, in particular a pH and/or a conductivity. The sensor 40 can be arranged downstream of the second mixer 39.

The electronic process control 7 can adjust the delivery rate of the fifth delivery device 36 in a neutralization routine 41 to set the target value for the liquid parameter in the fifth, resulting liquid flow 38. This can be done as a function of a deviation between an actual value determined by the measurement for the liquid parameter of the third, reactive liquid flow 26 and a predefined target value for the liquid parameter in the fifth, resulting liquid flow 38.

The conductivity can enable the electronic process control 7 to derive a buffer concentration. If, according to this exemplary embodiment, the actual pH in the third, reactive liquid flow 26 deviates from the target value for the liquid parameter in the fifth, resulting liquid flow 38, it can be possible for the electronic process control 7 to adjust the actual value of the liquid parameter, such as the actual pH or the actual conductivity, in the fifth, resulting liquid flow 38 by open-loop and/or closed-loop control of the fifth delivery device 36, which can be set up for the metered delivery of base, buffer and/or water.

By measuring the pH, the actual pH in the third, reactive liquid flow 26 can thus be determined on the one hand and, on the other hand, the electronic process control 7 can calculate the volume and/or volume flow required to achieve the target parameter in the fifth, resulting liquid flow 38, in particular the target pH, on the basis of the process data 15.

Alternatively, by measuring the conductivity, the actual conductivity in the third, reactive liquid flow 26 can be determined on the one hand and, on the other hand, the electronic process control 7 can calculate the volume and/or volume flow required to achieve the target value in the fifth, resulting liquid flow 38, in particular the target conductivity, on the basis of the process data 15.

According to various embodiments, the respective sensor 16, 29, 30, 31, 40 measures at least one parameter from the group comprising pH value, conductivity, fill level, change in fill level per time, delivery rate of at least one delivery device, flow rate of at least one liquid flow, protein concentration and/or other spectrophotometric properties of at least one liquid flow in order to generate the process data 15. In the embodiment with a plurality of sensors 16, 29, 30, 31, 40, at least two of them can measure the same or different parameters.

The electronic process control 7 can generate a second model 42 from the process data 15. The degree of adjustment of the delivery rate of the fourth and/or fifth delivery device 23, 36 can be derived from the second model 42. In various embodiments, the second model 42 represents the dependency between the liquid parameter of the third, reactive liquid flow 26 on the one hand and the delivery rate of the fourth delivery device 23 on the other hand. Additionally or alternatively, the second model 42 can represent the dependency between the liquid parameter of the fifth, resulting liquid flow 38 on the one hand and the delivery rate of the fifth delivery device 36 on the other hand. Based on this second model 42, in some embodiments at least the delivery arrangement 6 is controlled by the electronic process control 7. In various embodiments, as shown in FIG. 2, the electronic process control 7 calculates on the basis of the process data 15 which volume, volume flow or the like of the second liquid flow 25 must be added to the first liquid flow 24 containing a target factor in order to produce the target value of the liquid parameter in the third, reactive liquid flow 26, in particular the target pH or the target conductivity. In addition or alternatively, in some embodiments, as shown in FIG. 2, the electronic process control 7 calculates on the basis of the process data 15 which volume, volume flow or the like of the fourth liquid flow 37 must be added to the third, reactive liquid flow 26 in order to produce the target value of the liquid parameter in the fifth, resulting liquid flow 38, in particular the target pH or the target conductivity.

In particular, in a continuous in-line dilution process, the second model 42 calculates the degree of adjustment of the delivery rate of the fourth delivery device 23 can be based on at least one characteristic curve between the conductivity measured in the first liquid flow 24 comprising a target factor and a corresponding buffer concentration. Additionally or alternatively, the second model 42 calculates the degree of adjustment of the delivery rate of the fifth delivery device 36 can be based on at least one characteristic curve between the conductivity measured in the third reactive liquid flow 26 and a corresponding buffer concentration.

In various embodiments, the first model 21 and/or the second model 42 is a statistical model or an analytical model.

The term “statistical model” refers to a mathematical model in which some or all input data have a certain randomness, expressed for example by a probability distribution, so that for a given set of input data the output is not reproducible but is described by a probability distribution. Output data is obtained by running the model many times with a new input value, which is taken from the probability distribution for each run.

The term “analytical model” refers to a quantitative model that is used to answer a specific question. Its main objective is to provide a closed formula for certain characteristics. Analytical models are therefore mathematical models that have a closed-form solution, i.e., the solution to the equations used to describe changes in a system can be expressed as a mathematical analytical function.

In various embodiments, the liquid flow discharged from the bioprocess arrangement 1, in some embodiments the third, reactive liquid flow 26 or the fifth, resulting liquid flow 38, leaves the bioprocess arrangement 1 continuously. In various embodiments, the discharged third, reactive liquid flow 26 leaves the bioprocess arrangement 1 continuously through the disposal line 33. Alternatively, the discharged fifth, resulting liquid flow 38 leaves the bioprocess arrangement 1 continuously through the bioprocess outlet 11.

“Continuous” here means that the liquid flow 25, 35 leaving the bioprocess arrangement 1 is not interrupted, for example by incubation in a container or the like, and that it can vary in terms of flow rate.

In various embodiments, at least the first and/or second mixer 27, 39, in some embodiments all mixers, is set up for inline mixing of a liquid flow and is designed as a static mixer or as a centrifugal pump, in particular a centrifugal rotatory pump. It can be that the centrifugal pump for dynamic inline mixing is flowed through in the opposite flow direction compared to the intended operation.

In various embodiments, the method according to the proposal can be carried out in combination with an upstream, such as discontinuous or continuous, chromatography process, in particular affinity chromatography and ion exchange chromatography processes. Additionally or alternatively, the method according to the proposal is carried out in combination with an upstream, such as discontinuous or continuous, filtration process, in particular tangential flow filtration process or the like. Additionally or alternatively, a continuous chromatography or filtration process is carried out downstream of the method according to the proposal.

In principle, the method according to the proposal can be used in combination with all purification, filtration, chromatography, separation, centrifugation, concentration and/or sedimentation methods or other methods that can be assigned to downstream processes during a bioprocess.

According to various embodiments, a bioprocess arrangement 1 is provided for operating a continuous downstream process, in particular a continuous virus inactivation or inline dilution process, during a bioprocess. The bioprocess arrangement 1 has an expansion tank 2, with a first fluid inlet 3, set up for introducing a concentrate flow, in particular a product or buffer concentrate flow, into the expansion tank 2, and with at least one second fluid inlet 4, set up for introducing a diluent flow, in particular a product or buffer diluent flow, into the expansion tank 2. The bioprocess arrangement 1 has a fluid outlet 5, which is set up for discharging a liquid flow from the expansion tank 2. Furthermore, the bioprocess arrangement 1 has a delivery arrangement 6 for conveying fluid, which is assigned to the first fluid inlet 3 and the second fluid inlet 4 for conveying at least one liquid flow into the expansion tank 2 in each case. In addition, the delivery arrangement 6 is assigned to the fluid outlet 5 for conveying a liquid flow out of the expansion tank. The bioprocess arrangement 1 has an electronic process control 7.

A feature of the proposed bioprocess arrangement 1 is that during the intended operation of the bioprocess arrangement 1, the electronic process control 7 adjusts a fill level in the expansion tank 2 by open-loop and/or closed-loop control of the delivery arrangement 6. This adjustment is carried out in such a way that the fill level in the expansion tank 2 does not fall below a predefined minimum level in order to ensure a continuous liquid flow from the bioprocess arrangement 1.

In various embodiments, at least one component of the bioprocess arrangement 1, in some embodiments all components, is designed as a single-use component.

According to various embodiments, an electronic process control 7 of the bioprocess arrangement 1 according to the proposal is provided. Reference may be made in this respect to all explanations of the method according to the proposal for operating a continuous downstream process and of the bioprocess arrangement 1 according to the proposal.

In various embodiments, the line arrangement 12 is assigned a valve arrangement 34 with at least one valve for selective fluidic connection of the at least one line 13, in some embodiments all lines, of the line arrangement 12. The electronic process control 7 is set up by open-loop and/or closed-loop control of at least the delivery arrangement 6 for carrying out a method according to the proposal.

In various embodiments, the electronic process control 7 comprises a data processing system for realizing a method according to the proposal.

In various embodiments, the use of an electronic process control 7 for implementing a method according to the proposal is provided. Reference may be made in this respect to all explanations of the method according to the proposal for operating a continuous downstream process, to the bioprocess arrangement 1 according to the proposal and to the electronic process control 7 according to the proposal.

In various embodiments, a computer program for the electronic process control 7 according to the proposal is provided. Reference may be made in this respect to all explanations relating to the method according to the proposal for operating a continuous downstream process, to the bioprocess arrangement 1 according to the proposal, to the electronic process control 7 according to the proposal and to the use according to the proposal.

According to various embodiments, a computer-readable storage medium for storing the computer program according to the proposal is provided. Reference may be made in this respect to all explanations relating to the method according to the proposal for operating a continuous downstream process, to the bioprocess arrangement 1 according to the proposal, to the electronic process control 7 according to the proposal, to the use according to the proposal and to the computer program according to the proposal.

1. A method for operating a continuous downstream process, during a bioprocess using a bioprocess arrangement, wherein the bioprocess arrangement comprises an expansion tank with a first fluid inlet, set up for introducing a concentrate flow, into the expansion tank, with at least one second fluid inlet, set up for introducing a diluent flow, into the expansion tank, with a fluid outlet, set up for discharging a liquid flow from the expansion tank, the bioprocess arrangement having a delivery arrangement for conveying fluid, which is associated with the first fluid inlet and the second fluid inlet for conveying in each case at least one liquid flow into the expansion tank, and with the fluid outlet for conveying a liquid flow out of the expansion tank, and the bioprocess arrangement having an electronic process control, wherein the electronic process control adjusts a fill level in the expansion tank by open-loop and/or closed-loop control of the delivery arrangement in such a way that the fill level in the expansion tank does not fall below a predefined minimum fill level.

2. The method as claimed in claim 1, wherein the electronic process control adjusts the fill level in the expansion tank by open-loop and/or closed-loop control of the delivery arrangement in such a way that a predefined target fill level is reached or the fill level is maintained in a target fill level range.

3. The method as claimed in claim 1, wherein the delivery arrangement has a first delivery device for conveying fluid, which is assigned to the first fluid inlet, and/or the delivery arrangement has a second delivery device for conveying fluid, which is assigned to the second fluid inlet, and/or the delivery arrangement has a third delivery device for conveying fluid, which is assigned to the fluid outlet.

4. The method as claimed in claim 1, wherein the bioprocess arrangement has a bioprocess outlet which is set up for discharging a fluid from the bioprocess arrangement, the bioprocess arrangement has a line arrangement with at least one line for fluidic connection of the fluid outlet of the expansion tank to the bioprocess outlet and the third delivery device is set up for conveying fluid through the at least one line of the line arrangement.

5. The method as claimed in claim 1, wherein the bioprocess arrangement has a sensor arrangement for generating process data with at least one sensor assigned to the expansion tank, and the electronic process control derives an actual value for a filling level parameter in the expansion tank from the process data in a monitoring routine and
depending on a deviation between the derived actual value for the filling level parameter and a predefined minimum value for the filling level parameter corresponding to the predefined minimum filling level in the expansion tank, adjusts the delivery rate of the first, second and/or third delivery device to prevent the filling level from falling below the minimum filling level or
depending on a deviation between the derived actual value for the filling level parameter and a predefined target value for the filling level parameter corresponding to the predefined target filling level in the expansion tank, adjusts the delivery rate of the first, second and/or third delivery device to achieve the target filling level or
adjusts the delivery rate of the first, second and/or third delivery device to maintain the fill level in the target fill level range as a function of a deviation between the derived actual value for the fill level parameter and a predefined limit value of the predefined target fill level range in the expansion tank.

6. The method as claimed in claim 1, wherein the electronic process control generates a first model from the process data, and the degree of adjustment of the delivery rate of the delivery arrangement is derived from the first model.

7. The method as claimed in claim 1, wherein the bioprocess arrangement has a first bioprocess inlet downstream of the expansion tank, set up for introducing a liquid flow into the line arrangement of the bioprocess arrangement, and the delivery arrangement has a fourth delivery device which is assigned to the first bioprocess inlet and is set up for metered delivery of a liquid flow into the line arrangement.

8. The method as claimed in claim 1, wherein the concentrate flow is combined with the diluent flow in the expansion tank to form a first liquid flow containing a target factor, and the first liquid flow containing a target factor is introduced through the fluid outlet from the expansion tank into the at least one fluidically connected line of the line arrangement and is combined in a predefined volume ratio with a second liquid flow.

9. The method as claimed in claim 8, wherein the bioprocess arrangement has a first mixer set up for fluid mixing, and the third, reactive liquid flow is passed through the first mixer for fluid mixing.

10. The method as claimed in claim 8, wherein the bioprocess arrangement has a dwell time arrangement fluidically connected to the first mixer for providing a minimum dwell time of a liquid flow, and the third, reactive liquid flow is passed through the dwell time arrangement downstream of the at least one mixer for providing a minimum dwell time.

11. The method as claimed in claim 7, wherein the sensor arrangement for generating the process data comprises at least one sensor for measuring a liquid parameter of the first liquid flow containing a target factor and at least one sensor for measuring a liquid parameter of the third, reactive liquid flow.

12. The method as claimed in claim 11, wherein the electronic process control in a virus inactivation routine, depending on a deviation between an actual value determined by the measurement for the liquid parameter of the first liquid flow containing a target factor and the predefined target value for the liquid parameter in the third, reactive liquid flow, adjusts the delivery rate of the fourth delivery device for setting the target value for the liquid parameter in the third, reactive liquid flow.

13. The method as claimed in claim 1, wherein the line arrangement has a disposal line which is set up for discharging a liquid flow from the bioprocess arrangement.

14. The method as claimed in claim 1, wherein the line arrangement is assigned a valve arrangement with at least one valve for the selective fluidic connection of at least one line of the line arrangement.

15. The method as claimed in claim 1, wherein the bioprocess arrangement has a second bioprocess inlet, set up for introducing a liquid flow into the line arrangement of the bioprocess arrangement, the delivery arrangement has a fifth delivery device, which is assigned to the second bioprocess inlet and is set up for metered delivery of a liquid flow into the line arrangement.

16. The method as claimed in claim 1, wherein the respective delivery device is designed as a metering pump, or as a valve.

17. The method as claimed in claim 1, wherein the bioprocess arrangement comprises at least one second mixer, set up for fluid mixing, and the fifth, resulting liquid flow is passed through the second mixer for fluid mixing.

18. The method as claimed in claim 1, wherein the sensor arrangement for generating the process data has at least one sensor for measuring a liquid parameter of the fifth, resulting liquid flow, and the electronic process control in a neutralization routine adjusts the delivery rate of the fifth delivery device for setting the target value for the liquid parameter in the fifth, resulting liquid flow as a function of a deviation between an actual value, determined by the measurement, for the liquid parameter of the third, reactive liquid flow and a predefined target value for the liquid parameter in the fifth, resulting liquid flow.

19. The method as claimed in claim 1, wherein the respective sensor for generating the process data measures at least one parameter from the group consisting of: pH value, conductivity, filling level, change in filling level per time, delivery rate of at least one delivery device, flow rate of at least one liquid flow, protein concentration and other spectrophotometric properties of at least one liquid flow.

20. The method as claimed in claim 1, wherein the electronic process control generates a second model from the process data, the degree of adjustment of the delivery rate of the fourth and/or fifth delivery device is derived from the second model, and/or the second model represents the dependence between the liquid parameter of the fifth, resulting liquid flow on the one hand and the delivery rate of the fifth delivery device on the other hand.

21. The method as claimed in claim 6, wherein the first model and/or the second model is a statistical model or an analytical model.

22. The method as claimed in claim 1, wherein the liquid flow discharged from the bioprocess arrangement leaves the bioprocess arrangement continuously.

23. The method as claimed in claim 1, wherein at least the first and/or second mixer are set up for inline mixing of a liquid flow and are designed as static mixers or as centrifugal pumps.

24. The method as claimed in claim 1, wherein the method is carried out in combination with an upstream, chromatography process and/or filtration process, and/or a continuous chromatography or filtration process is connected downstream of the method according to the proposal.

25-30. (canceled)
